(19) United States
(12) Patent Application Publication
(10) Pub. No.: US 2007/0278040 A1
(43) Pub. Date: Dec. 6, 2007

(54) LADDER SECURING PLATE

(76) Inventor: Rick A. Rager, Warrenton, MO (US)

Correspondence Address: CHARLES C. MCCLOSKEY, 763 S. NEW BALLAS ROAD STE. 170, ST. LOUIS, MO, 63141, US

(21) Appl. No.: 11/422,507

(22) Filed: Jun. 6, 2006

(51) Int. Cl. E06C 7/42

(52) U.S. Cl. 182/107

(57) ABSTRACT

A flat plate grips a roof and has an opening to admit up to a double fly ladder. Opposite the opening, the plate has a plurality of slots in at least two ranks for adjusting the position of the plate relative to a gable. The underside of the plate has a roof engaging surface to reduce slippage of the plate. The plate can be carried in vehicles and readily lifted to the height of a roof. The plate also includes slots extending parallel to the length of the plate, a tread pattern upon the top surface of the plate, sizing to fit within corrugations of metal roofing, and hand holes for transport and emergency grasping.

### BACKGROUND OF THE INVENTION

The ladder securing plate generally relates to ladders and more specifically to a plate that secures a ladder away from the eave or gable of a building.

For centuries, people have placed ladders against buildings for various purposes including, framing, plastering, sheathing, roofing, guttering, painting, and fire fighting among others. In recent times, buildings have used gutters at the eaves to remove rainwater and snowmelt and edge trims to dress up gables of buildings. Following the various purposes, ladders are placed against a building often at the eave or the gable. Inattentive or sloppy handling of a ladder by a worker or crew of a contractor may damage a gutter or dent an edge trim. Damaged parts require repair or often replacement at the expense of the contractor.

When a ladder is placed against a gable, the ladder contacts the building at two points, each at a slightly different elevation due to the roof pitch. The elevation difference provides an opportunity for the ladder to twist or kick out from the bottom which puts a worker at risk of a fall. On gables, workers must use caution when placing and using ladders.

Sometimes ladders are placed in one location for long term use which wears on the roof as workers climb off the ladder and onto the roof, and when workers climb off of the roof and onto the ladder. For longer term use, a more stable securement of a ladder to a building is desirable over resting the ladder upon an edge of the building.

Ladders come in two types, single fly and double fly. A single fly ladder has rungs between two side rails. The side rails are parallel and spaced apart with the rungs perpendicular to the rails. The rails define the length of the ladder and its reach upwards upon a building. A double fly ladder has two sections of ladder. Each section has two parallel side rails and rungs between them. The rails have a somewhat “I” shape that permits nesting of flanges of the side rails of the two sections. The flanges of the top of one section overlap the flanges of the bottom of the second section, generally the upper section. The upper section may have a slightly narrower width than the lower section. Often a rope and pulley arrangement connects the second section to the first section to permit raising the second section by a worker from the ground. Single fly and double fly ladders are used by contractors, businesses, and government agencies of all kinds to reach higher parts of buildings.

### DESCRIPTION OF THE PRIOR ART

Seeking to reach a higher part of a building, a worker has many ladders and accessories from which to choose. The ladders vary in height which the worker selects based upon the building subject to the job. The accessories are chosen by the worker based upon the job. Often the accessories allow the ladder to stand away from a building to prevent damaging the building as previously described. The accessories include rubber or other non-marring ends upon the upper section of a ladder, blocks and rags tied to the top of the ladder, arcuate brackets that reach over a gutter to a roof, padded hooks that gently attach to a gutter, leg assemblies that attach to the side rails, and various scaffolding systems among other things. The leg assemblies extend symmetrically away from a ladder and end in non-marring feet that contact a building. The leg assemblies serve well on the gable end of a building.

However, non-marring ends wear over time and expose the ends of the rails. Non-marring ends also detach from the rails when rivets or other connectors give way. Perhaps useful at the moment, blocks and rags may fall off the ladder and do bring the ladder closer to a building. The arcuate brackets require attachment to the side rails before usage and attentive handling by a worker. Though padded, hooks may still damage a gutter and still permit twisting of the ladder when placed upon a gable end. Similar to the brackets, the leg assemblies require connection to the ladder prior to usage, attentive handling by a worker when erecting a ladder to avoid window damage, and still contact the building. The leg assemblies must be set properly or a worker will remain too far from a building which requires lowering the ladder and resetting the leg assemblies.

### SUMMARY OF THE INVENTION

Generally, the present invention provides a flat plate suitable for gripping a lo roof that has an opening to admit up to a double fly ladder. Opposite the opening, the plate has a plurality of slots in at least two ranks for adjusting the position of the plate relative to a gable. The underside of the plate has a roof engaging surface to reduce slippage of the plate. The plate can be carried in most contractor vehicles and readily lifted to the height of a roof.

There has thus been outlined, rather broadly, the more important features of the invention in order that the detailed description thereof that follows may be better understood and that the present contribution to the art may be better appreciated.

The present invention also includes slots extending parallel to the length of the plate, a tread pattern upon the top surface of the plate, sizing to fit within corrugations of metal roofing, and hand holes for transport and emergency grasping.

Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved ladder securing plate.

Another object is to provide such a ladder securing plate that abuts a building without a ladder marring the building.

Another object is to provide such a ladder securing plate that promotes safety at heights and at the edges of roofs.

Another object is to provide such a ladder securing plate that attaches to a is roof at an angle on the gable end to prevent twisting of the ladder.

Another object is to provide such a ladder securing plate that grips the roof surface and provides slip and skid resistance when walked upon.

Another object is to provide such a ladder securing plate that receives both single and double fly ladders.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a top view of the present invention;

FIG. 2 shows a bottom view of the present invention;

FIG. 3 is a perspective view of the present invention installed upon an eave for supporting a ladder;

FIG. 4 is a perspective view of the present invention installed upon a gable at an angle; and,

FIG. 5 is a top view of an alternate embodiment showing hand holes.

The same reference numerals refer to the same parts throughout the various figures.

### DESCRIPTION OF THE PREFERRED EMBODIMENT

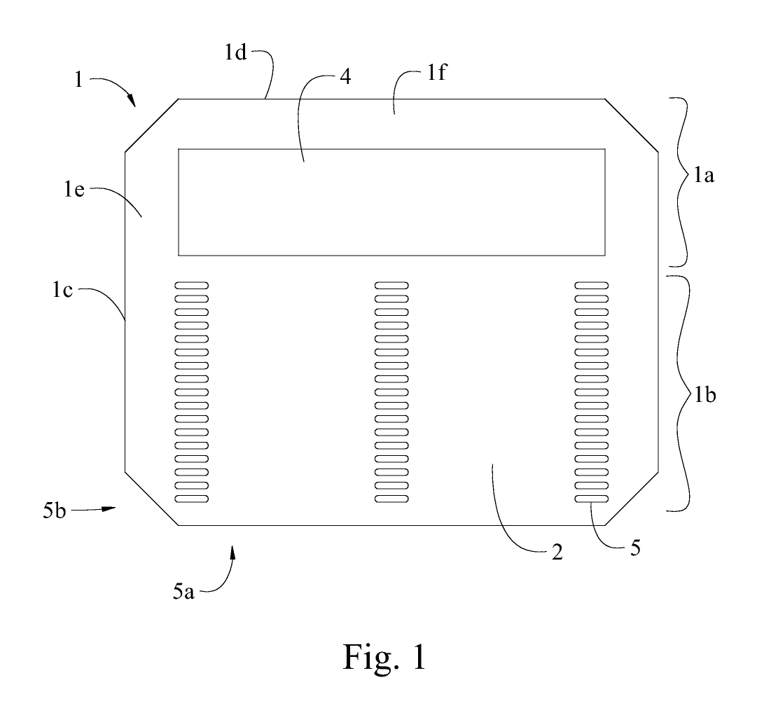

The present art overcomes the prior art limitations by providing a plate 1 with an opening to admit a ladder 2 while the plate is secured to a roof R at the eave E or the gable end 61. Beginning on FIG. 1, the ladder securing plate 1 has a generally rectangular planar shape with a top surface 2 and an opposite bottom surface 3. FIG. 1 illustrates the plate with the top surface showing. The plate has two mutually parallel and spaced apart lateral edges 1c and two mutually parallel and spaced apart longitudinal edges 1d, perpendicular to the lateral edges. The longitudinal edges generally have a length greater than that of the width of one flight of a ladder. The lateral edges and the longitudinal edges join together to complete the perimeter of the plate. In the preferred embodiment, a lateral edge joins to a longitudinal edge in a truncated or beveled corner.

Parallel to and towards one longitudinal edge, the plate has an opening 4 to receive a flight F of a ladder. The opening occupies generally one third of the width of the plate as shown by the portion so labeled 1a. The opening is rectangular in a similar orientation to the plate as a whole. The opening has rounded corners and a width greater than the thickness of a flight. Proximate to the lateral edges, the opening has ends 1e and proximate to the longitudinal edge away from the interior of the plate, the opening has a rail 1f. The width of the opening allows a flight to be inserted at an angle through the plate.

Away from the opening towards the other longitudinal edge so labeled as portion 1b, the plate has at least two files 5a of slots 5 arranged in ranks 5b. Each slot 5 has a generally flattened oval shape and a length much less than that of the opening. In the preferred embodiment, each slot is approximately two inches long and one half inch wide, with three files and at least three ranks. The lo slots are arranged parallel to the opening.

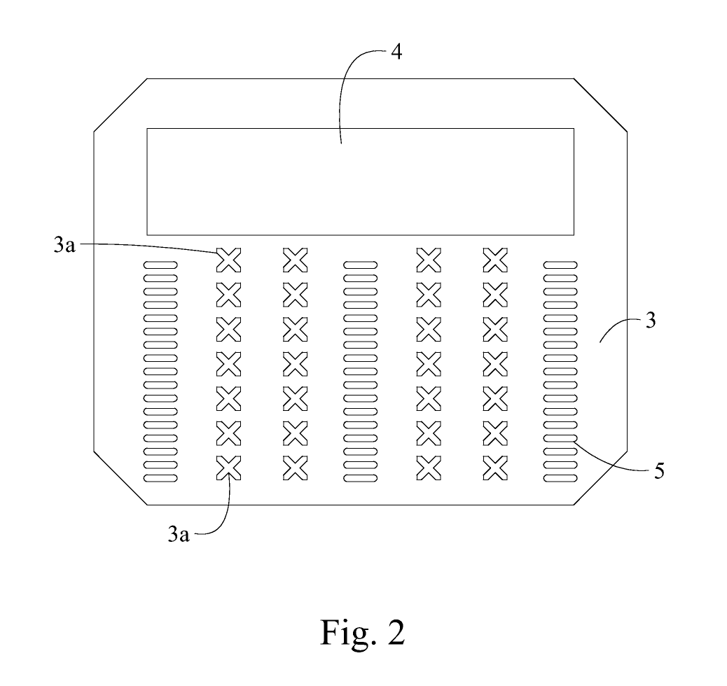

Turning the plate over, FIG. 2 shows the bottom surface 3 of the plate. The bottom surface also has the opening 4 to admit a ladder and the pattern of slots 5 parallel to the opening as previously described. The bottom surface differs from the top surface by a slip resistant texture 3a. The slip resistant texture allows the bottom surface to grip a roof when the plate is installed and provides a texture reflected in the top surface 2 for the footwear of workers to grip. In the preferred embodiment, the bottom surface has a diamond tread pattern as the slip resistant texture.

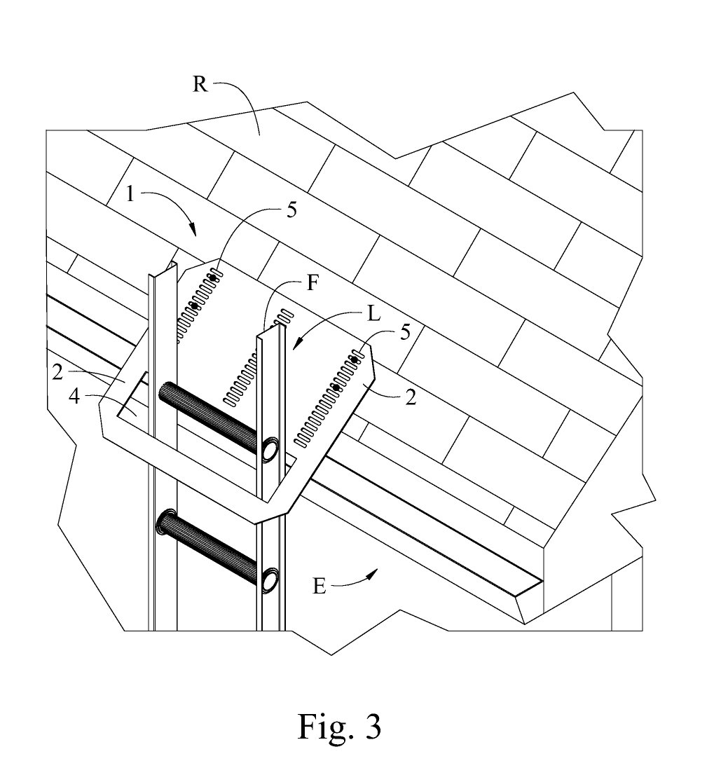

As previously described, workers who access roofs of buildings often position ladders upon an edge of the building. Such positioning allows a worker to climb the ladder from the ground adjacent to a building up to the roof without entering the building. FIG. 3 shows the present invention installed upon a roof R near an eave E, or low end of a roof with a pitch. The ladder plate 1 is installed flat upon the roof, generally directly upon the roof surface with the top surface 2 upwards. The ladder plate is positioned so the opening 4 is outwards from the eave E, often beyond the gutter or other trim condition. Generally the opening 4 is parallel to the eave E. Fasteners, such as roofing nails or screws, are then placed through a certain minimum number of slots 5. The fasteners in cooperation with the texture upon the bottom surface of the plate secure the plate into position at the eave. A flight F of a ladder L is then inserted through the opening 4 from below. The ladder extends through the opening with enough rungs above the plate to provide safe climbing on and off the ladder at the roof level. The ladder rests upon the opening, generally upon the edge of the opening towards the interior of the plate. Workers then climb and descend the ladder normally as the ladder rests on the plate but not the gutter.

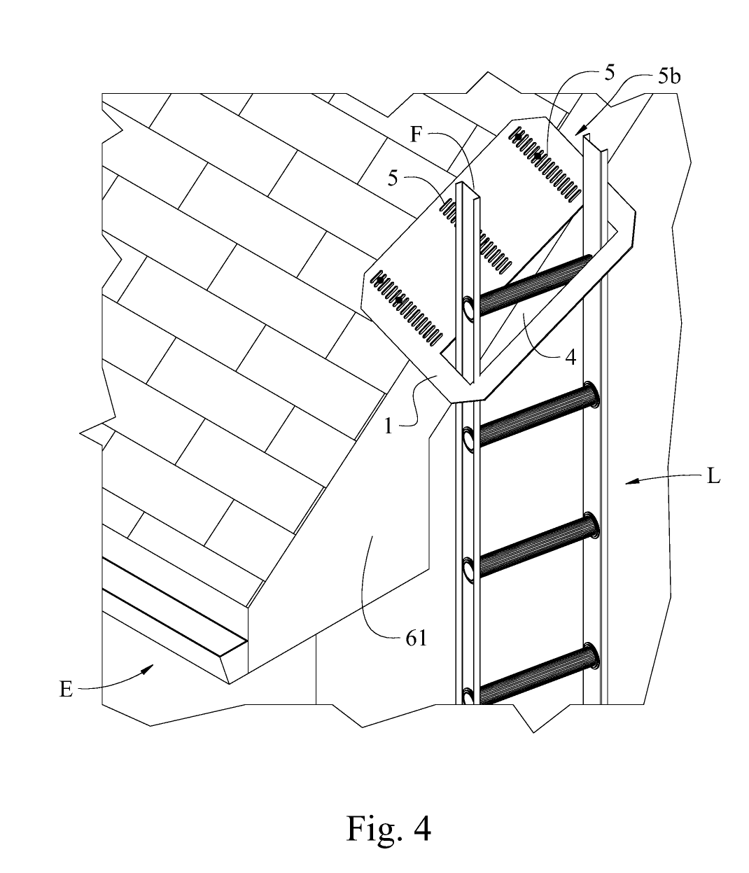

For some tasks upon the roof, workers access the gable end 61 of a building. The gable end is perpendicular to the eave and generally rises with the lo pitch, or slope of the roof as shown in FIG. 4. A ladder 1 placed upon a gable end contacts the gable end at two spaced apart locations having different elevations established by the roof pitch. The elevation difference allows the ladder to twist upon its axis when a worker climbs the ladder. In some situations, the twist can lead to the worker spilling from the ladder or the ladder rotating and then sliding down the gable end, putting the worker at grave risk of falling. The ladder plate 1 also installs upon the gable end of a roof R. As before, the bottom surface 3 of the plate is applied to the roof with the opening 4 extending outwards from the gable, generally beyond the trim installed upon the building. The slots are located upon the roof surface with the plate partially rotated away from the ridge. Fasteners, such as roofing nails or screws, are then placed through the slots to secure the plate in the partially rotated position. The partial rotation of the plate, generally towards the eave, positions the later to counteract twisting of it and allows a worker to position a ladder parallel to the gable end of a building.

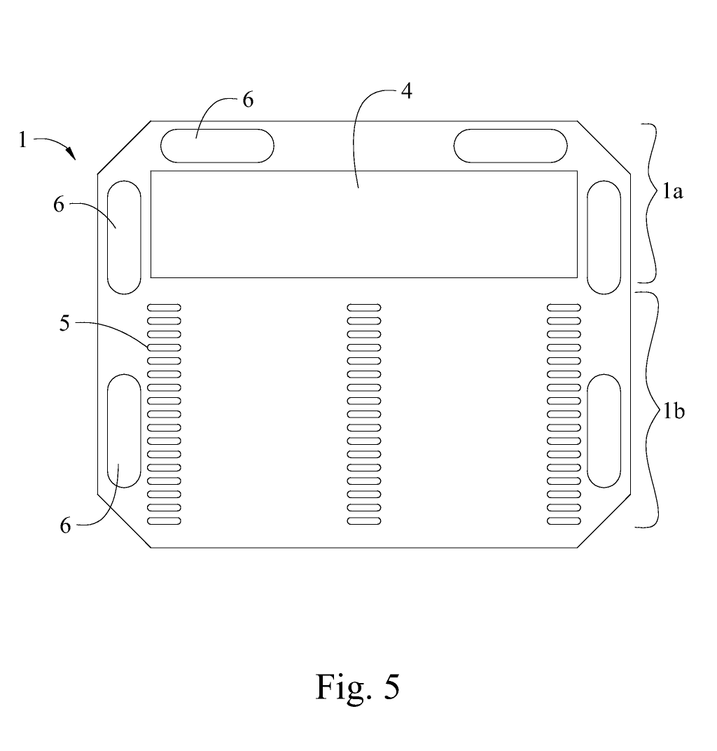

FIG. 5 shows an alternate embodiment of the plate. In usage, the plate of the present invention is transported to a building and then carried up to the roof. An advance team of workers lifts a plate for installation on the roof. The workers can grasp the plate by gripping the longitudinal edge however, the width of that edge may tire a worker's fingers. The alternate embodiment provides a plurality of hand holes 6 through the plate that are spaced around the perimeter of the plate and generally located near the corners.

Also, the hand holes provide, a worker climbing the ladder or a worker near the edge of the roof, a place to grab the plate in an emergency. In a fall situation, a worker will grasp an edge of the plate. However, the planar shape of the plate limits the grip allowed for a worker's fingers, to the top surface in the vicinity of an edge of the plate. Hand holes narrow the width of the plate between the hand hole and the longitudinal edge or lateral edge. A worker can then grasp the narrowed width of the plate at a hand hole during normal or emergency lo usage of the plate.

From the aforementioned description, a ladder securing plate has been described. The plate is uniquely capable of installing at an angle upon a gable end of a roof and admitting one flight of a ladder through an opening in the plate. The ladder securing plate and its various components may be manufactured from many materials, including but not limited to, steel, aluminum, polymers, polyvinyl chloride, high density polyethylene, polypropylene, nylon, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device for temporarily securing a ladder, having at least one flight, adjacent to a roof of a building, comprising:
a plate, having a generally planar shape with a width substantially greater than a thickness and a length substantially greater than the width, a top surface and an opposite bottom surface;
said plate having an opening therethrough, said opening having a shape to admit a flight and a plurality of slots.

2. The ladder securing device of claim 1 further comprising:
said opening having a generally rectangular shape less in width than half of the width of said plate and less in length than the length of said plate;
said opening locating in one half of said plate and said plurality of slots locating in the other half of said plate; and,
said bottom surface being a skid resistant.

3. The ladder securing device of claim 2 further comprising:
said plurality of slots having a pattern of at least two files of slots and each of said files having at least three ranks of slots.

4. The ladder securing device of claim 4 wherein said slots have a substantially greater length than width.

5. The ladder securing device of claim 2 further comprising:
a plurality of hand holes spaced along the perimeter of said plate, outwards of said opening and said slots.

6. A device for temporarily securing a ladder, having at least one flight, adjacent to a roof of a building, comprising:
a plate, having a generally planar shape with a width substantially greater than a thickness and a length substantially greater than the width;
said plate having an opening therethrough, said opening having a shape to admit a flight, and a plurality of slots;
said plate securing to the roof by a plurality of fasteners.

7. The ladder securing device of claim 6 further comprising:
said plate securing parallel to the edge of the roof.

8. The ladder securing device of claim 6 further comprising:
said opening having a generally rectangular shape less in width than half of the width of said plate and less in length than the length of said plate;
said opening locating in one half of said plate and said plurality of slots locating in the other half of said plate.
said plurality of slots having a pattern of at least two files of slots and each of said files having at least three ranks of slots; and,
said plate securing at an angle to the edge of the roof as at least one file moves generally inwards upon said roof and at least one other file moves is generally outwards from said roof.
